(19) United States
(12) Patent Application Publication
(10) Pub. No.: US 2021/0404600 A1
(43) Pub. Date: Dec. 30, 2021

(54) HANGING DEVICE

(71) Applicant: Brandon THORNTON, Houston, TX (US)

(72) Inventor: Brandon THORNTON, Houston, TX (US)

(21) Appl. No.: 17/468,664

(22) Filed: Sep. 7, 2021

Related U.S. Application Data
(63) Continuation of application No. PCT/US2020/021360, filed on Mar. 6, 2020.
(60) Provisional application No. 62/815,176, filed on Mar. 7, 2019.

(51) Int. Cl. F16M 13/02; F16B 2/00; A47G 29/08

(52) U.S. Cl. CPC F16M 13/022; G10G 5/00; A47G 29/083; F16B 2/005

(57) ABSTRACT

This invention provides a self-clamping device for hanging objects from a supporting element. In one embodiment, the device has a body, a holding arm, a pivot arm and a clamping arm, the pivot arm and the clamping arm are affixed to the body, the holding arm projects from the body forming a holding point between the holding arm and the body for hanging objects; and the pivot arm is configured to contact a top side of the supporting element, forming a pivot point; an object hanging from the holding point generates a torque about the pivot point to thrust the end of the clamping arm against a bottom side of the supporting element forming a clamping point.

### CROSS-REFERENCE TO RELATED APPLICATIONS

This application claims the benefit of U.S. Provisional Application No. 62/815,176, filed Mar. 7, 2019. The entire contents and disclosures of the preceding application are incorporated by reference into this application.

Throughout this application, various references are referred to and disclosures of these publications in their entireties are hereby incorporated by reference into this application to more fully describe the state of the art to which this invention pertains.

### FIELD OF THE INVENTION

The present invention relates to a portable self-clamping device for hanging objects, such as bags, purses, handbags, totes, backpacks and shopping bags from surface of tables, desks, shelves, cupboards or other supporting elements. The application cites various publications, the entire contents of which are incorporated herein by reference into this application.

### BACKGROUND OF THE INVENTION

When people are in some public spaces like restaurants, cafés, bars or libraries, they usually find it is hard to a place to hold their belongings like purses, handbags, totes, backpacks, shopping bags and instruments in a secure way that will not restrict their movement or contaminate their luggage.

The present invention provides a self-clamping device for hanging objects, such as bags, purses, handbags, totes, backpacks, shopping bags and instruments in the above-mentioned scenario.

The present invention provides users an easy-to-hang and easy-to-take function. Users can take off or hang the objects without removing the device from surface of tables, desks, shelves, cupboards or other supporting elements, which makes the invention more convenient to use.

### SUMMARY OF THE INVENTION

The present invention relates to a self-clamping device for hanging objects from a supporting element, comprising a body, a holding arm, a pivot arm and a clamping arm, wherein: a) Said pivot arm and said clamping arm are affixed said body, wherein said holding arm projects from said body forming a holding arm and said body for hanging objects; and b) Said pivot arm is configured to contact a top side of said supporting element, forming a pivot point; wherein an object hanging from said holding point generates a torque about said pivot point to thrust the end of said clamping arm against a bottom side of said supporting element forming a clamping point.

In one embodiment, the supporting element is selected from the group consisting of table top, desk top, shelf, door, and cupboard top.

In one embodiment, the holding arm is the shortest arm among these three arms. In one embodiment, the pivot or the clamping arm is the shortest arm. In one embodiment, the pivot arm is longer than the clamping arm. In one embodiment, the pivot arm is shorter than the clamping arm. In one embodiment, the pivot arm and the clamping arm have the same length. In one embodiment, the supporting element has two sides or surfaces. In one embodiment, the supporting element has more than two sides or surfaces. In one embodiment, the supporting base has more than two sides or surfaces. In one embodiment, one or more of the arms are made up of two or more sub-arms. In one embodiment, one or more of the arms are foldable. In one embodiment all the arms are configured to be unfolded.

In one embodiment, the device in its entirety can be made collapsible or foldable. In one embodiment, it comprises 2 or more individual pieces, wherein connection pins, screws, solder, or ball joint are used to connect the pieces.

In one embodiment, the holding arm is functionalized via another hook or hanging arm. In one embodiment, another hook or hanging arm is connected to the holding arm via a chain or any other connecting part.

In the present invention, the device can be held in position by itself. In one embodiment, an object hanging from said holding point generates a torque about said pivot point to thrust the end of said clamping arm against a bottom side of said supporting element forming a clamping point. In one embodiment, the pivot point, clamping point, and holding point are approximately on the same vertical plane. In one embodiment, the pivot point, clamping point, and holding point are approximately on two or three different vertical planes. In some embodiments, the weight of the device and the objects adds force on the surface of the supporting element via the pivot point and clamping point. In one embodiment, the force holds the whole device in position. In one embodiment, the friction force between pivot point, clamping point and one or more surfaces of the supporting element keep the device from moving. In one embodiment, the pivot arm and clamping arm increase the friction force between pivot point, clamping point and one or more surfaces of the supporting element by creating more contact area.

### BRIEF DESCRIPTION OF THE FIGURES

FIG. 1A shows an embodiment of the self-clamping device of this invention before being loaded, said device comprising: a body (1), holding arm (2), pivot arm (3) and clamping arm (4), wherein the holding point (21), the pivot point (31), and the clamping point (41) are configured to have a plane of rotation perpendicular to the edge of the supporting element, such as a table.

FIG. 1B shows the same embodiment in FIG. 1A after loading, wherein the weight of the object at the holding point (21) induces a torque at the pivot point (31) to cause the clamping point (41) to push against the supporting element, stabilizing the device.

FIG. 2A shows the side view of an embodiment of this invention, wherein the holding point (21), pivot point (31), and clamping point (41) are configured to have a plane of rotation parallel to the edge of the supporting element.

FIG. 2B shows the top view of the embodiment in FIG. 2A demonstrating the advantage of manipulating the rotational plane with design of the holding point (21), pivot point (31), the clamping point (41), wherein part of the bag can be positioned under the table to save space.

FIG. 3 shows two embodiments of the pivot arm (3) of this invention, wherein the pivot point is designed to confine the rotational plane. In one embodiment, the pivot arm is made up of two sub-arms. In one embodiment, the pivot arm only comprises one sub-arm.

FIG. 4A shows the front view of an embodiment of this invention wherein the device can be folded elegantly into a keychain-like structure; the holding arm is attached to the body (1) via a pin connection (22).

FIG. 4B shows the top view of the embodiment in FIG. 4A, wherein the pivot arm (3) is attached to the body (1) via a hinge joint (32), and the clamping arm is hidden in the body or underneath the pivot arm, and both arms can be rotated out of the body.

FIG. 4C shows the back view of the embodiment in FIG. 4A, wherein both pivot arm (3) and clamping arm (4) are attached to the body via hinge joints (32, 42).

FIG. 4D shows the front view of the embodiment in FIG. 4A ready to be deployed for clamping, wherein the holding arm is opened, and the pivot arm and clamping arm are posed on the same side of the body and perpendicular to the backside of the body.

FIG. 4E shows top view of the embodiment in FIG. 4D.

FIGS. 5A and 5B show a device according to one embodiment wherein the pivot arm (3) is shorter than the clamping arm (4), wherein the holding arm (2) is integrated with the straight body (1).

FIGS. 6A and 6B show a device according to one embodiment wherein the pivot arm (3) is longer than the clamping arm (4).

FIGS. 7A and 7B show a device according to one embodiment wherein the clamping arm (4) is longer than the pivot arm (3).

FIGS. 8A and 8B show a device according to one embodiment wherein the curved clamping arm (4) is longer than the pivot arm (3), wherein a hook is connected to the holding arm (2) with a chain, wherein the holding arm (2) is integrated with the curved body (1).

FIGS. 9A and 9B show a device according to one embodiment wherein the curved clamping arm (4) is longer than the pivot arm (3), wherein a hook is connected to the holding arm (2) with a connection ring, wherein the holding arm (2) is integrated with the curved body (1).

FIGS. 10A and 10B show a device according to one embodiment wherein the curved clamping arm (4) is shorter than the pivot arm (3).

FIGS. 11A and 11B show a device according to one embodiment wherein the curved clamping arm (4) is longer than the pivot arm (3).

FIGS. 12A to 12D show a device according to one embodiment wherein the curved clamping arm (4) is foldable and longer than the pivot arm (3).

FIGS. 13A to 13D show a device according to one embodiment wherein the curved clamping arm (4) is longer than the pivot arm (3), and both arms are foldable.

FIGS. 14A to 14D show a device according to one embodiment wherein the curved clamping arm (4) is longer than the pivot arm (3), and both arms and the holding arm (2) are foldable.

FIGS. 15A and 15B show a device according to one embodiment wherein the curved clamping arm (4) is longer than the pivot arm (3), and both arms and the holding arm (2) are tubular.

FIG. 16 shows the side view of a prototype.

FIG. 17 shows the top view of a prototype.

FIG. 18 shows the bottom view of a prototype.

FIG. 19 shows the side view of a prototype clamping to the edge of a table top.

FIG. 20 shows the top view of a prototype clamping to the edge of a table top.

FIG. 21 shows the side view of a prototype clamping to the edge of a table top while loaded with a shopping bag.

### DETAILED DESCRIPTION OF THE INVENTION

The present invention relates to a self-clamping device for hanging objects from a supporting element, comprising a body, a holding arm, a pivot arm and a clamping arm, wherein:

a) Said pivot arm and said clamping arm are affixed said body, wherein said holding arm projects from said body forming a holding arm and said body for hanging objects; and b) Said pivot arm is configured to contact a top side of said supporting element, forming a pivot point; wherein an object hanging from said holding point generates a torque about said pivot point to thrust the end of said clamping arm against a bottom side of said supporting element forming a clamping point.

In one embodiment, supporting element includes but is not limited to table top, desk top, shelf, door, cupboard top, or other subjects with surfaces to support such device.

In the present invention, the device can be held in position by itself. In one embodiment, an object hanging from said holding point generates a torque about said pivot point to thrust the end of said clamping arm against a bottom side of said supporting element forming a clamping point. In one embodiment, the pivot point, clamping point, and holding point are approximately on the same vertical plane. In one embodiment, the pivot point, clamping point, and holding point are approximately on two or three different vertical planes. In sonic embodiments, the weight of the device and the objects adds force on the surface of the supporting element via the pivot point and clamping point. In one embodiment, the force holds the whole device in position. In one embodiment, the friction force between pivot point, clamping point and one or more surfaces of the supporting element keep the device from moving. In one embodiment, the pivot arm and clamping arm increase the friction force between pivot point, clamping point and one or more surfaces of the supporting element by creating more contact area.

In one embodiment, this invention provides a self-clamping device that can be elegantly folded for easy packing.

In some embodiments, the pivot point can be a flat, curved, squared, or angular surface.

In some embodiments, the clamping point can be a flat, curved, squared, or angular surface.

In one embodiment, the body is straight or curved.

In one embodiment, the ends of the body are bent.

In one embodiment, the pivot arm is made up of two or more sub-arms configured to contact a top side of a supporting element with an increased contact area.

In one embodiment, the clamping arm is made up of two or more sub-arms configured to contact a bottom side of a supporting element with an increased contact area.

In one embodiment, the holding arm is made up of two or more sub-arms configured to hold multiple objects or objects of different shapes.

In one embodiment, notches or groove is added to the part of arms in contact with the supporting element to increase the friction between the pivot point, the clamping point and supporting element.

In one embodiment, the pivot point and/or the clamping point are equipped with an anti-slip pad, wherein the anti-slip pad is a layer of polymer, polymer composition, natural rubber, or the combination thereof to increase the friction between the clamping points and flat surface without scratching or damaging the surface.

In some embodiments, the pivot arm or the clamping arm does not necessarily need to be curved. The pivot arm and the clamping arm can be produced in an angled, rectangular, squared, or straight and non-curvilinear fashion.

In one embodiment, the hook in its entirety can be made collapsible or foldable. In one embodiment, it comprises 2 or more individual pieces, wherein connection pins, screws, solder, or ball joint are used to connect the pieces.

In one embodiment, the holding arm is functionalized via another hook or hanging arm. In one embodiment, another hook or hanging arm is connected to the holding arm via a chain or any other connecting part, allowing the hanged object to swivel or change its orientation.

In one embodiment, the body can be extended or contracted to save space or to accommodate larger or odd shaped objects.

In one embodiment, the holding arm can be extended or contracted to save space or to accommodate larger or odd shaped objects.

In one embodiment, the pivot arm can be extended or contracted to save space or to further stabilize the device on thick surfaces or surfaces with curved or angled edges.

In one embodiment, the clamping arm can be extended or contracted to save space or to further stabilize the device on thick surfaces or surfaces with curved or angled edges.

In one embodiment, the body is telescopic to save space or to accommodate larger or odd shaped objects.

In one embodiment, the holding arm is telescopic to save space or to accommodate larger or odd shaped objects.

In one embodiment, the pivot arm is telescopic to save space or to further stabilize the device on thick surfaces or surfaces with curved or angled edges.

In one embodiment, the clamping arm is telescopic to save space or to further stabilize the device on thick surfaces or surfaces with curved or angled edges.

In one embodiment, the device should be foldable and adjustable to increase its portability, but also be used on any supporting base.

In one embodiment, the holding arm projects from the upper part of the body. In one embodiment, the holding arm projects from the middle part of the body. In one embodiment, the holding arm projects from the lower part of the body.

In one embodiment, the body is made in tubular structure to increase portability by reducing the device weight.

In one embodiment, the holding arm is made in tubular structure to increase portability by reducing the device weight.

In one embodiment, the pivot arm is made in tubular structure to increase portability by reducing the device weight.

In one embodiment, the clamping arm is made in tubular structure to increase portability by reducing the device weight.

In one embodiment, the body can be made of polymer, ceramic, wood, aluminum, aluminum alloy or steel.

In one embodiment, the holding arm can be made of polymer, ceramic, wood, aluminum, aluminum alloy or steel.

In one embodiment, the pivot arm can be made of polymer, ceramic, wood, aluminum, aluminum alloy or steel.

In one embodiment, the clamping arm can be made of polymer, ceramic, wood, aluminum, aluminum alloy or steel.

In one embodiment, the device can be made of polymer, ceramic, wood, aluminum, aluminum alloy or steel.

In one embodiment, the device is fabricated via Computer Numerical Control (CNC) machining.

In one embodiment, the device is fabricated via 3D printing.

In one embodiment, the device is prepared via molding or milling.

In one embodiment, the self-clamping device for hanging objects from a supporting element, comprising a body, a holding arm, a pivot arm and a clamping arm, wherein: a) Said pivot arm and said clamping arm are affixed to said body, wherein said holding arm projects from said body forming a holding point between said holding arm and said body for hanging objects; and b) Said pivot arm is configured to contact a top side of said supporting element, forming a pivot point; wherein an object hanging from said holding point generates a torque about said pivot point to thrust the end of said clamping arm against a bottom side of said supporting element forming a clamping point.

In one embodiment, the pivot point, clamping point, and holding point are approximately on the same or two or three different vertical planes.

In one embodiment, wherein the body is straight or curved.

In one embodiment, wherein the ends of the body are bent.

In one embodiment, wherein one or more of the holding arm, the pivot arm and clamping arm are integrated with the body.

In one embodiment, wherein the holding arm, the pivot arm and/or the clamping arm are affixed to the body via connection pins, screws, solder, or ball joint.

In one embodiment, wherein the pivot arm is made up of two or more sub-arms configured to contact a top side of a supporting element with an increased contact area.

In one embodiment, wherein the clamping arm is made up of two or more sub-arms configured to contact a bottom side of a supporting element with an increased contact area.

In one embodiment, wherein the holding arm is made up of two or more sub-arms configured to hold multiple objects or objects of different shapes.

In one embodiment, wherein a hook is connected to said holding arm via a connection pin or connection chain.

In one embodiment, wherein the hook is made of a material selected from the group consisting of polymer, ceramic, wood, aluminum, aluminum alloy and steel.

In one embodiment, wherein said pivot arm and/or said clamping arm are equipped with an anti-slip pad to avoid slipping when said arms are in contact with a supporting element.

In one embodiment, wherein said anti-slip pad is made of a polymer,

In one embodiment, wherein said polymer is selected from the group consisting of natural rubber, synthetic rubber, polyurethane, epoxy resin, polyester, polyether, silicone resin or rubber, polyol, and polyacid.

In one embodiment, wherein the part of the pivot arm and/or the clamping arm in contact with the supporting element is equipped with notches to avoid slipping.

In one embodiment, wherein the body, the holding arm, the pivot arm and/or the clamping arm are foldable.

In one embodiment, wherein the body, the holding arm, the pivot arm and/or the clamping arm are rotatable.

In one embodiment, wherein the body, the holding arm, the pivot arm and/or the clamping arm are telescopic.

In one embodiment, wherein each of the body, holding arm, the pivot arm and the clamping arm is independently made of a material selected from the group consisting of polymer, ceramic, wood, aluminum, aluminum alloy and steel.

In one embodiment, wherein the supporting element is selected from the group consisting of table top, desk top, shelf, door, and cupboard top.

In one embodiment, this invention provides a self-clamping device for hanging objects from a supporting element, comprising a body, a holding arm, a pivot arm and a clamping arm, wherein: a) Said pivot arm and said clamping arm are affixed to said body, wherein said holding arm projects from said body forming a holding point between said holding arm and said body for hanging objects; and b) Said pivot arm is configured to contact a top side of said supporting element, forming a pivot point; wherein an object hanging from said holding point generates a torque about said pivot point to thrust the end of said clamping arm against a bottom side of said supporting element forming a clamping point.

In one embodiment, said clamping arm and said pivot arm forms a space to receive an edge of said supporting element, said torque has a plane of rotation that is approximately perpendicular or approximately parallel to said edge.

In one embodiment, said device comprises a curvilinear surface at said pivot point or said clamping point.

In one embodiment, one or more of the holding arm, the pivot arm and the clamping arm are integrated with the body.

In one embodiment, the holding arm, the pivot arm and/or the clamping arm are affixed to the body via connection pins, screws, solder, or ball joint.

In one embodiment, the device further comprises a stabilizing mechanism configured to increase frictional force at said pivot point or said clamping point. In another embodiment, said stabilizing mechanism comprises two or more sub-arms, a material of high friction coefficient or notches at said pivot point or said clamping point. In a further embodiment, said material of high friction coefficient is a polymer. In yet another embodiment, said polymer is selected from the group consisting of natural rubber, synthetic rubber, polyurethane, epoxy resin, polyester, polyether, silicone resin or rubber, polyol, and polyacid.

In one embodiment, the holding arm comprises a holding mechanism configured to hold multiple objects or objects of specific shapes. In another embodiment, said holding mechanism is selected from the group consisting of two or more sub-arms, open-end ring, suction cup, hook, sax hanger, and guitar hook. In a further embodiment, said holding mechanism is connected to said holding arm via a connection pin or connection chain. In yet another embodiment, the hook is made of a material selected from the group consisting of polymer, ceramic, wood, aluminum, aluminum alloy and steel.

In one embodiment, the body, the holding arm, the pivot arm and/or the clamping arm are foldable.

In one embodiment, the body, the holding arm, the pivot arm and/or the clamping arm are rotatable.

In one embodiment, the body, the holding arm, the pivot arm and/or the clamping arm are telescopic.

In one embodiment, each of the body, the holding arm, the pivot arm and the clamping arm is independently made of a material selected from the group consisting of polymer, ceramic, wood, aluminum, aluminum alloy and steel.

In one embodiment, the supporting element is selected from the group consisting of table top, desk top, shelf, door, chair and cupboard top. In another embodiment, supporting element can be the seat or back of the chair.

In one embodiment, this invention provides a method for hanging an object on a supporting element, comprising the steps of: a) providing the device of this invention to an edge of a supporting element; and hanging said object onto the holding arm. In another embodiment, said supporting element is selected from the group consisting of table top, desk top, shelf, door, chair and cupboard top.

In one embodiment, this invention provides a self-clamping device for hanging objects from a supporting element, comprising a body having two ends, a holding arm, a pivot arm and a clamping arm, wherein: said pivot arm and said clamping arm are affixed to each end of said body forming a bended structure wherein the arms and the body are in the same plane, said holding arm projects from said body, and is coplanar with the body; wherein when said pivot arm is placed on a top side of said supporting element forming a pivot point; and an object hangs from said holding arm, a torque is generated about said pivot point to thrust the open end of said clamping arm against a bottom side of said supporting element forming a clamping point.

The invention will be better understood by reference to the Experimental Details which follow, but those skilled in the art will readily appreciate that the specific experiments described are only for illustrative purpose and are not meant to limit the invention as described herein, which is defined by the claims that follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### EXAMPLE 1

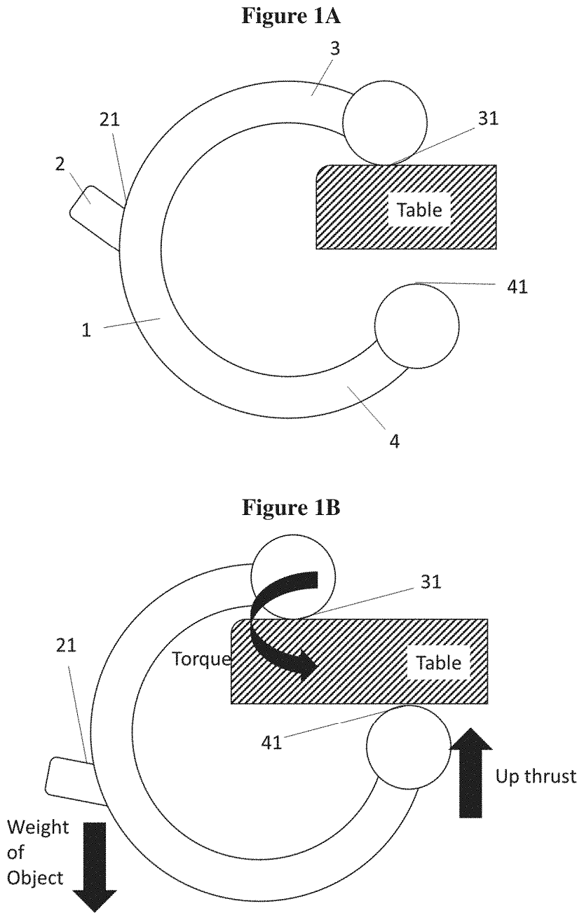

In one embodiment, this invention provides a device with a self-clamping mechanism for hanging objects from a supporting element. In another embodiment, the device comprises a body (1), a holding arm (2), a pivot arm (3) and a clamping arm (4) as shown in FIG. 1A. When the pivot arm is placed onto a supporting element such as a table, the point of contact between the pivot arm and the supporting element will form a pivot point (31) such that a load placed onto a holding point (21) at the holding arm (2) will create a torque to thrust the clamping arm (4) onto the bottom side of the table at the clamping point (41). In this way, the force balance will lock the device in place so that it will not fall off easily. In one embodiment, there is a horizontal distance, between the holding point and pivot point which can act as a lever arm for creating a torque.

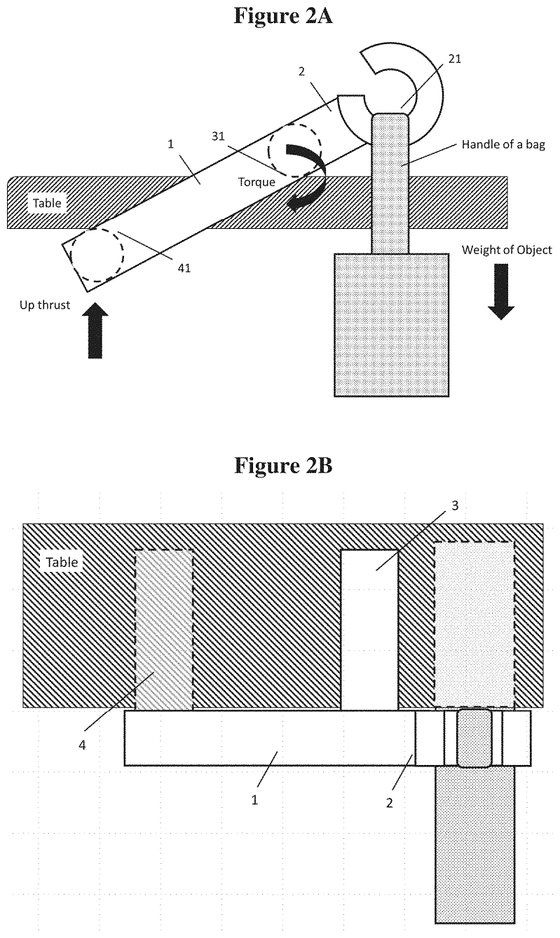

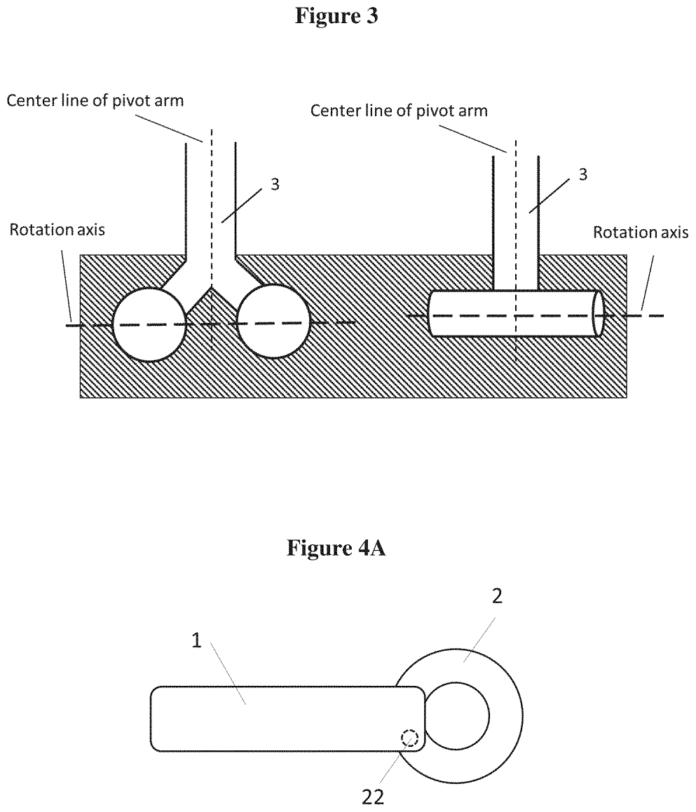

By careful design of the holding arm (2), pivot arm (3) and clamping arm (4), the plane of rotation can be manipulated. In FIG. 1B, for example, the three arms are configured such that the plane of rotation is perpendicular to the edge of the table. On the other hand, in FIG. 2A, the plane of rotation is parallel to the edge of the table. This may be advantageous to objects having unique shapes e.g. in FIG. 2B, the long side of the handbag being perpendicular to the table edge will save space.

In one embodiment, the center of gravity of the device is controlled to generate the torque at the pivot point to activate the self-clamping mechanism without any hanging object. In another embodiment, the clamping arm will not thrust against the bottom side of the supporting element without any hanging object.

In one embodiment, the gap between the pivot arm and the clamping arm is sufficiently large to accommodate supporting elements of different thickness. When thickness of a supporting element is smaller than the gap between the pivot arm and the clamping arm, the self-clamping mechanism will close any gap between the clamping arm and the bottom side of the supporting element.

In one embodiment, the pivot point comprises a mechanism to confine the rotation resulting from the torque to a specific plane. In another embodiment, the mechanism is a cylindrical shape with the rotation axis along the long side of the cylindrical shape. In a further embodiment, the mechanism comprises two contact points defining a rotation axis (FIG. 3). Due to the above designs having structures protruding from the center line of the pivot arm, there will be more resistance to external forces arising from, e.g., hitting from the sides.

Further to the structures at the pivot arm, the device can also comprise a stabilizing mechanism to provide extra support. In one embodiment, the stabilizing mechanism comprises a structure contacting the supporting element at one or more contact points. In one embodiment, the frictional force at the one or more contact points is configured to be increased by increasing surface area of contact, having notches or a material of high frictional co-efficient.

In one embodiment, the holding arm comprises a holding mechanism adapted to hold objects of unique shapes such as guitar or saxophone. In one embodiment, the holding mechanism is an open-end ring, e.g. FIGS. 2A and 2B, so that the object can be held regardless of the tilting angle of the body. In another embodiment, the holding mechanism is attached to the holding arm via a pin connection or other mechanism that allows the object to remain vertical regardless of the tilting angle of the body.

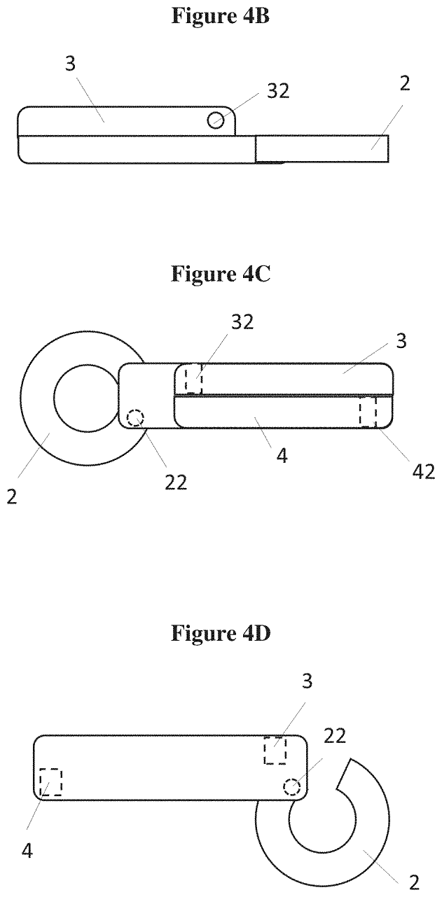

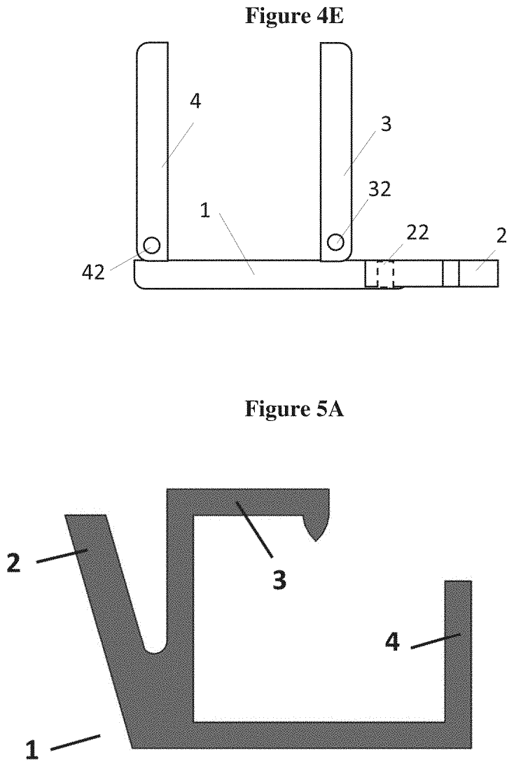

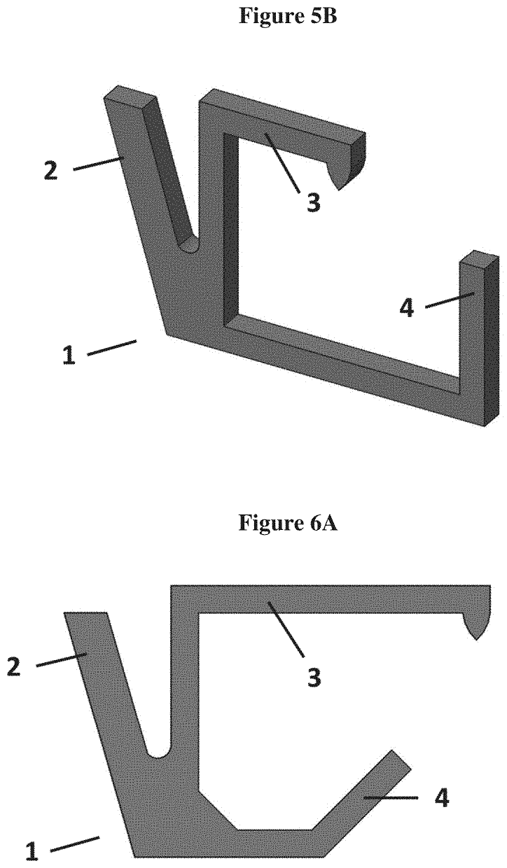

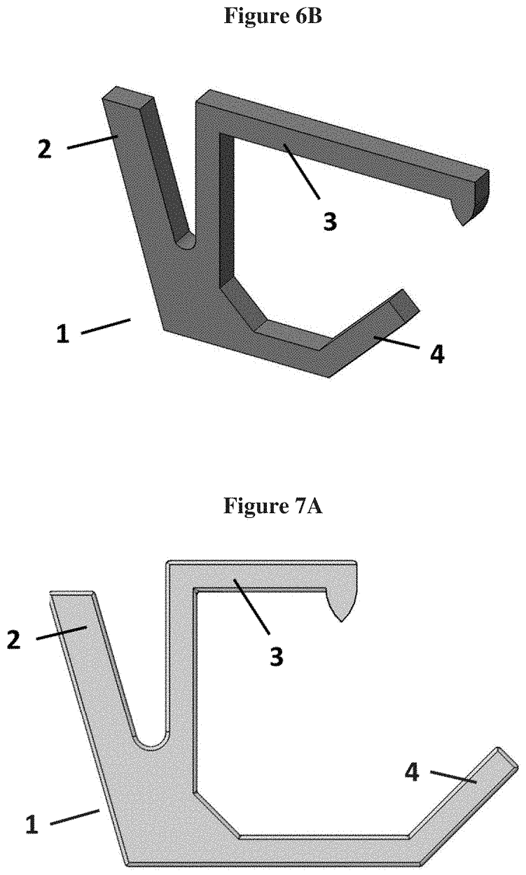

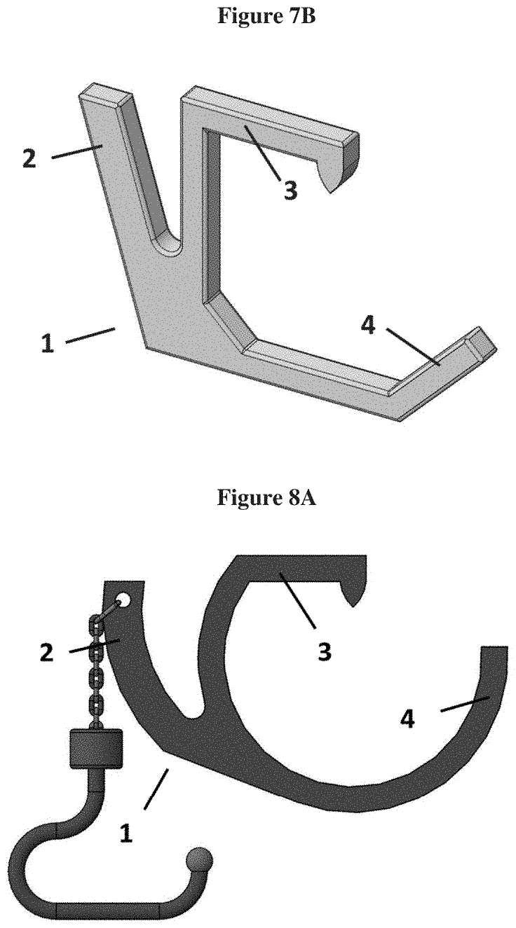

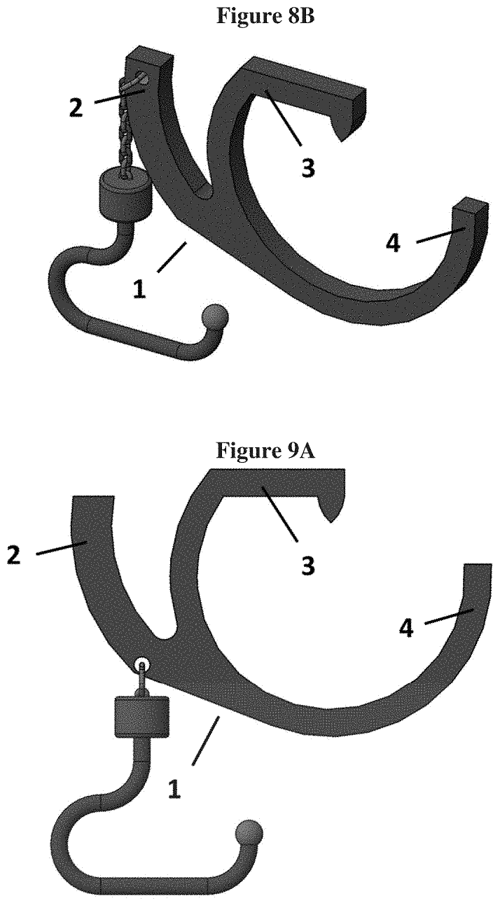

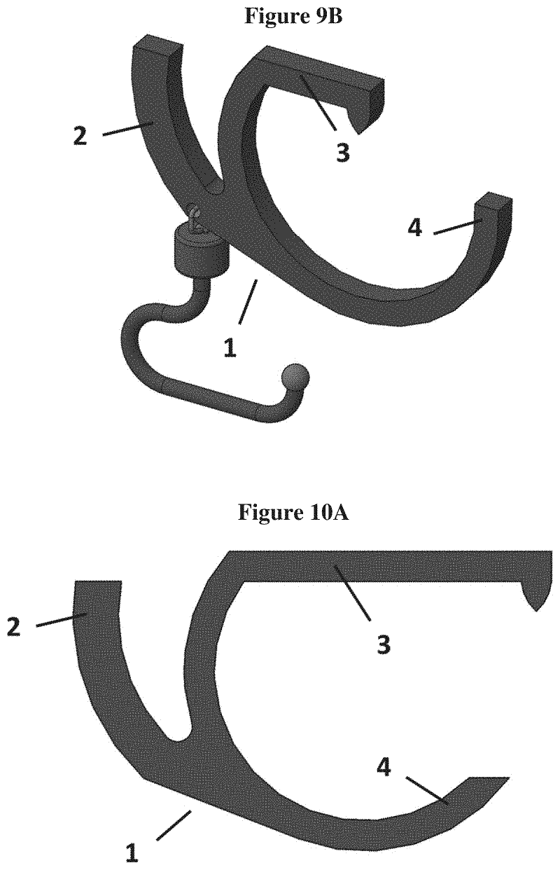

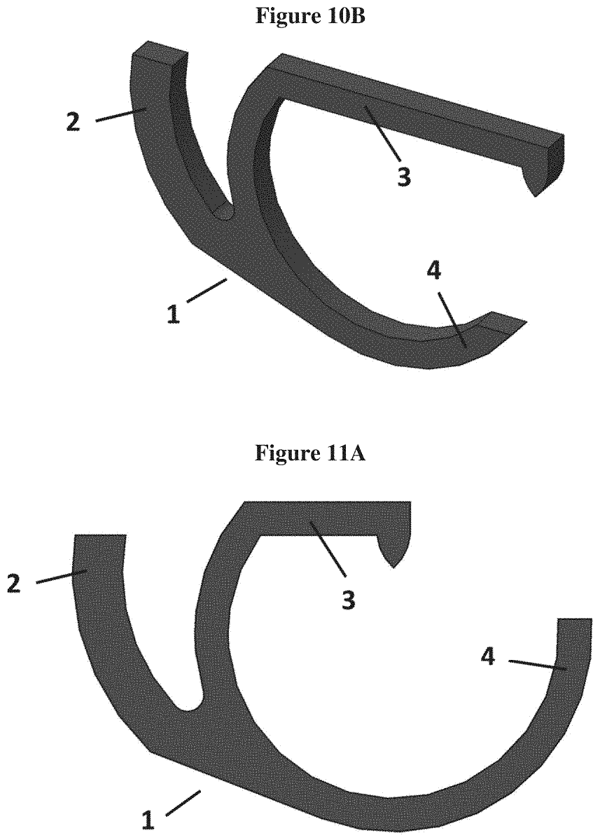

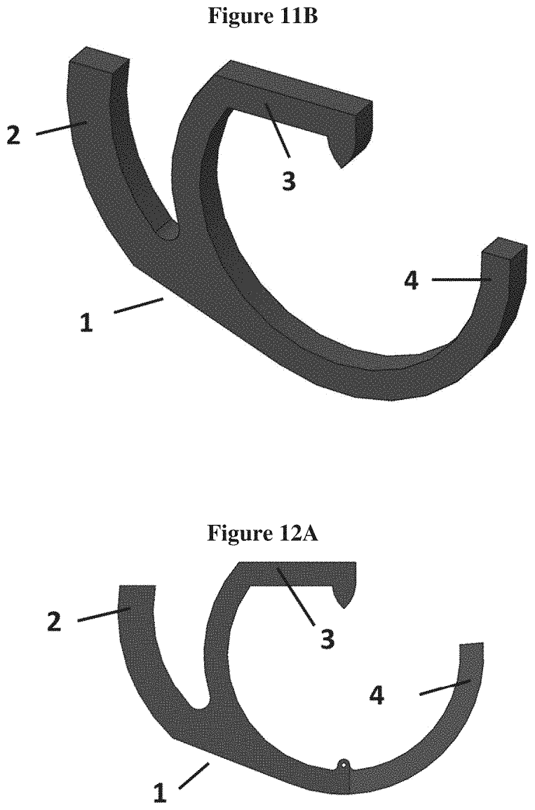

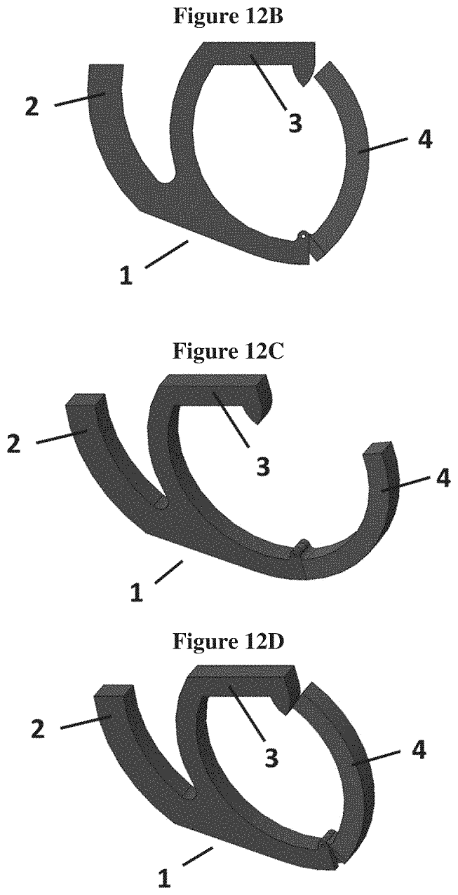

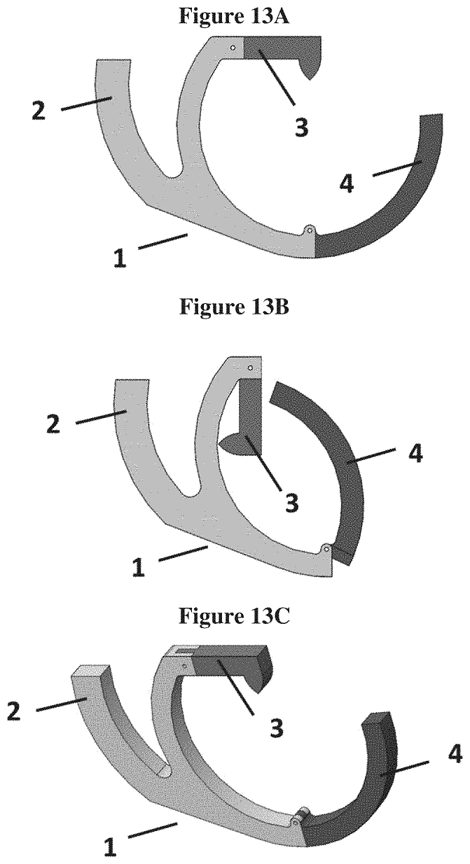

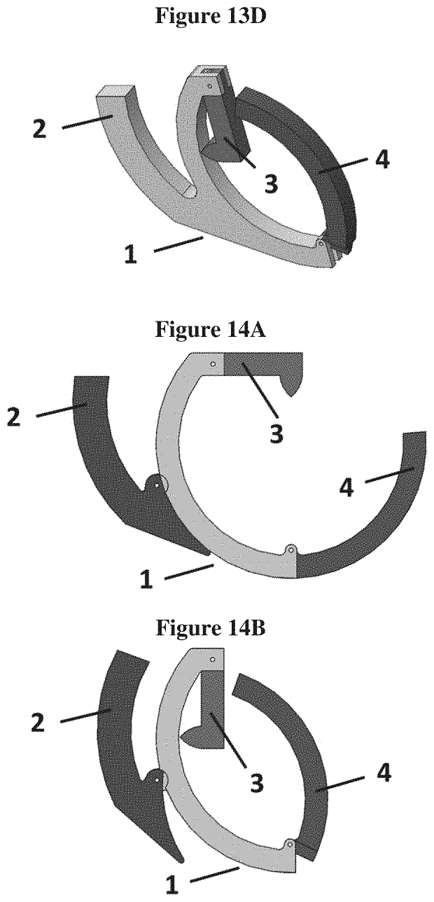

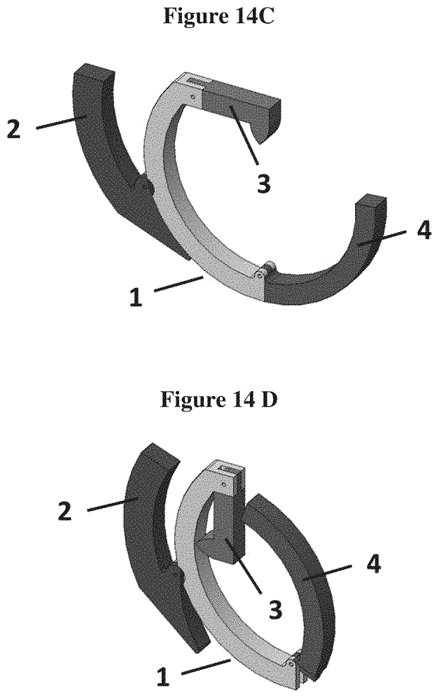

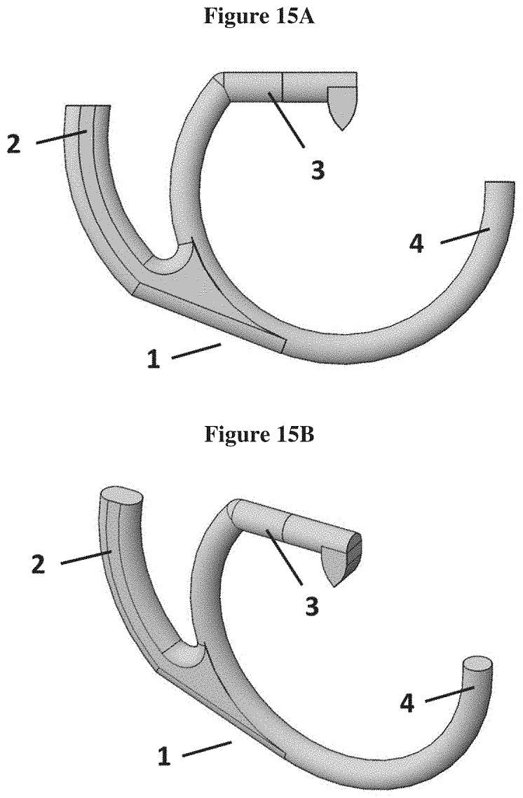

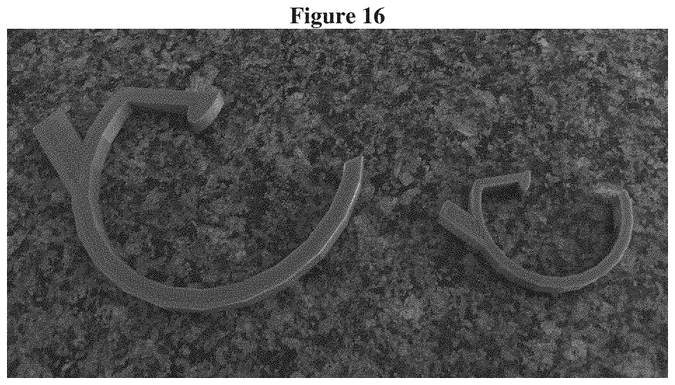

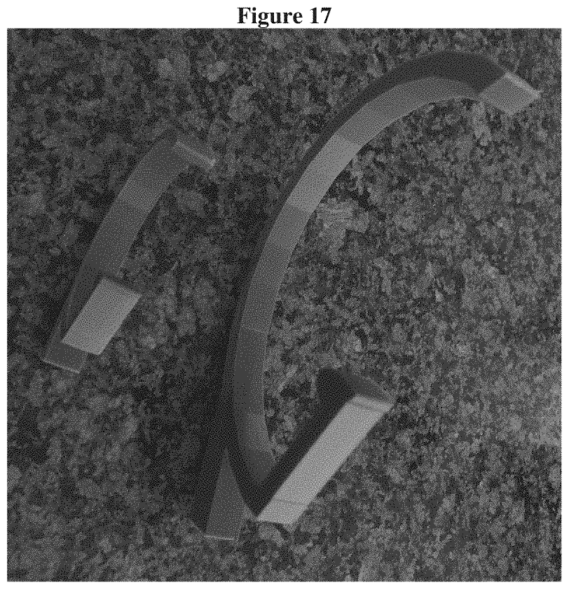

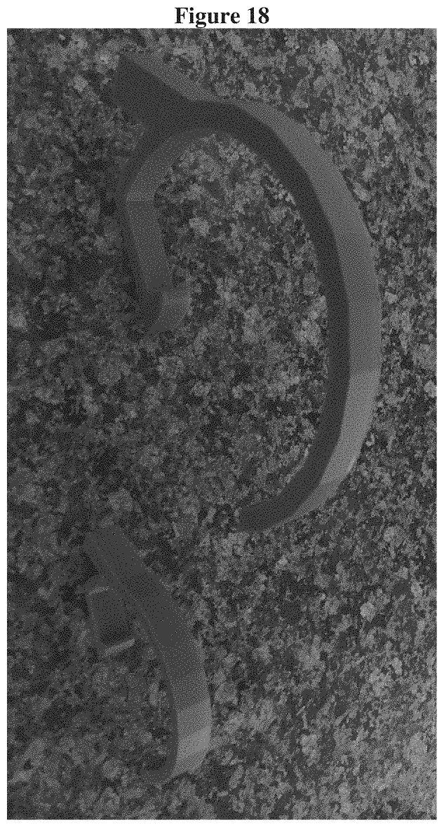

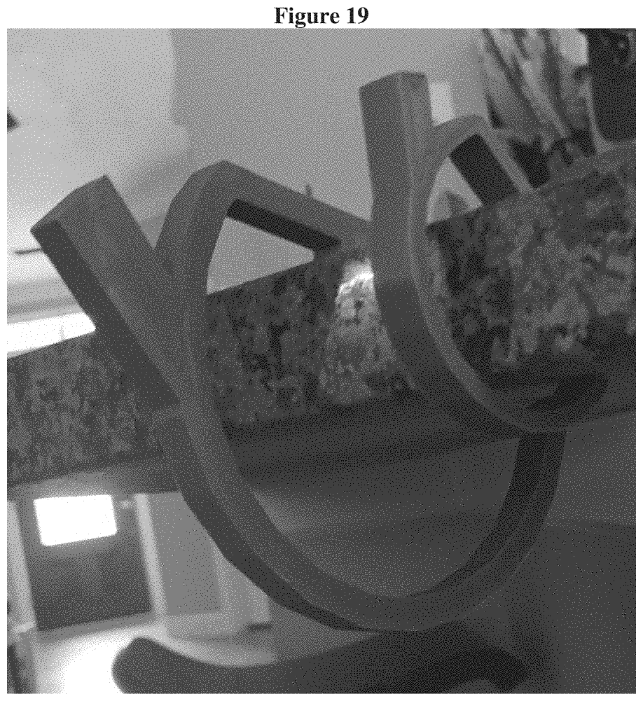

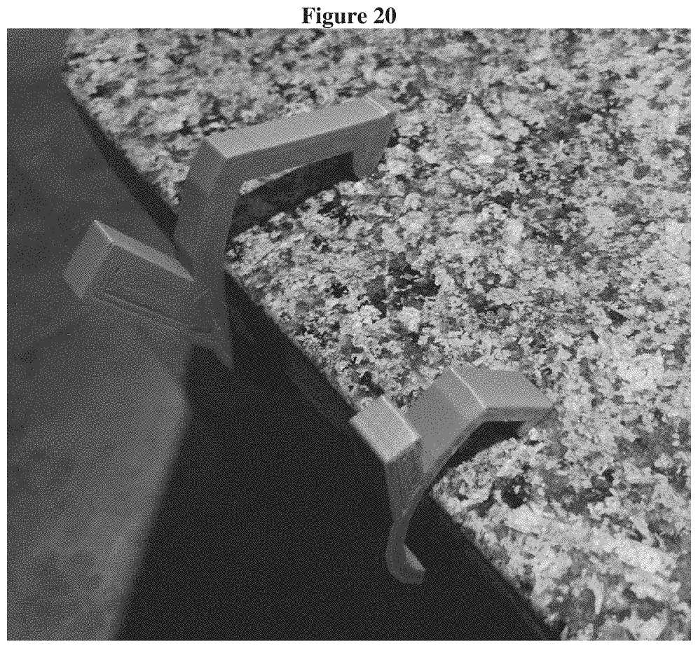

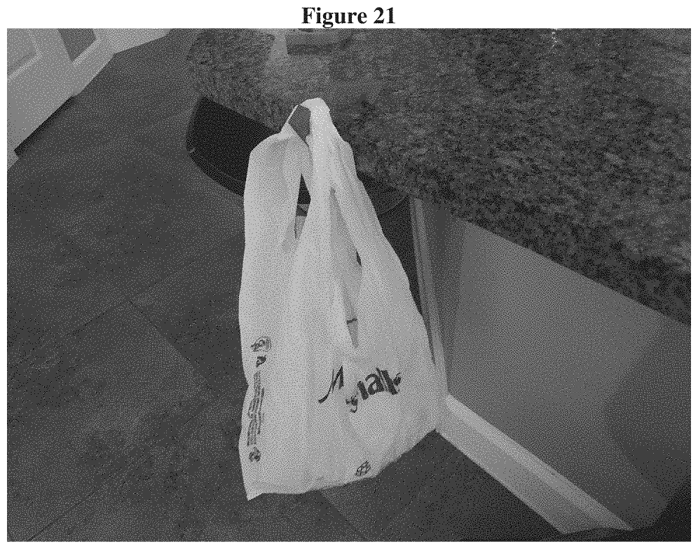

In one embodiment, this invention provides a self-clamping device that can be elegantly folded for easy packing. FIGS. 4A to 4E show an embodiment of this invention whereby the self-clamping device is folded into a keychain like structure. The pivot arm (3) and clamping arm (4) are connected by hinge joints (32, 42) to the body so that they can be folded towards the body. The holding arm (2) is an open-end ring that is attached to the body by a pin connection at one end. The other end of the open-end ring can be part of a locking mechanism for reversible connection to the body. When being deployed for clamping, the pivot arm and clamping arm are posed to be perpendicular to the body and the holding arm released from the locking mechanism. After placement of the object into the holding arm, the open-end ring can be locked back to the body so that the object will not easily fall out. In another embodiment, an object, e.g. a handbag handle, can be placed into the holding arm and locked with the locking mechanism such that, when the object needs to be hang, the user merely needs to unfold the pivot arm and clamping arm.

In one embodiment, the body can be designed to have ornamental features or even 3D structures as long as the pivot arm and clamping arms can firmly attach to it.

### EXAMPLE 2

The portable self-clamping device is fabricated by the following steps:
1. Designing the device of this invention using a software e.g. Ultimaker Cura.
2. 3D-printing the device via a 3D Printer, e.g. Monoprice® Maker Select, by using filaments of Acrylonitrile Butadiene Styrene (ABS), thereby obtaining the device.

### EXAMPLE 3

According to one embodiment of the present invention, the 3D-printed device is used in the following procedures:
1. Obtaining the device according to the preparation method Example 1;
2. Attaching the pivot arm of the device to the top surface of a table, creating a pivot point wherein a torque generated about the pivot point by the device's weight thrusts the end of the clamping arm against the bottom side of the table, creating a clamping point, wherein the device is secured to the table with the help of its own weight;
3. After the device is clamped to the table, hanging a handbag to the holding arm generates additional torque about the pivot point to thrust the end of the clamping arm with more force, further securing the device to the table;
4. When needed, taking the handbag off the holding arm; and
5. Removing the device from the table.

What is claimed is:

1. A self-clamping device for hanging objects from a supporting element, comprising a body, a holding arm, a pivot arm and a clamping arm, wherein:
a. Said pivot arm and said clamping arm are affixed to said body, wherein said holding arm projects from said body forming a holding point between said holding arm and said body for hanging objects; and
b. Said pivot arm is configured to contact a top side of said supporting element, forming a pivot point;
wherein an object hanging from said holding point generates a torque about said pivot point to thrust the end of said clamping arm against a bottom side of said supporting element forming a clamping point.

2. The device of claim 1, wherein said clamping arm and said pivot arm forms a space to receive an edge of said supporting element, said torque has a plane of rotation that is approximately perpendicular or approximately parallel to said edge.

3. The device of claim 1, wherein said device comprises a curvilinear surface at said pivot point or said clamping point.

4. The device of claim 1, wherein one or more of the holding arm, the pivot arm and the clamping arm are integrated with the body.

5. The device of claim 1, wherein the holding arm, the pivot arm and/or the clamping arm are affixed to the body via connection pins, screws, solder, or ball joint.

6. The device of claim 1, wherein the device further comprises a stabilizing mechanism configured to increase frictional force at said pivot point or said clamping point.

7. The device of claim 6, wherein said stabilizing mechanism comprises two or more sub-arms, a material of high friction coefficient or notches at said pivot point or said clamping point.

8. The device of claim 7, wherein said material of high friction coefficient is a polymer.

9. The device of claim 8, wherein said polymer is selected from the group consisting of natural rubber, synthetic rubber, polyurethane, epoxy resin, polyester, polyether, silicone resin or rubber, polyol, and polyacid.

10. The device of claim 1, wherein the holding arm comprises a holding mechanism configured to hold multiple objects or objects of specific shapes.

11. The device of claim 10, wherein said holding mechanism is selected from the group consisting of two or more sub-arms, open-end ring, suction cup, hook, sax hanger, and guitar hook.

12. The device of claim 10, wherein said holding mechanism is connected to said holding arm via a connection pin or connection chain.

13. The device of claim 11, wherein the hook is made of a material selected from the group consisting of polymer, ceramic, wood, aluminum, aluminum alloy and steel.

14. The device of claim 1, wherein the body, the holding arm, the pivot arm and/or clamping arm are foldable.

15. The device of claim 1, wherein the body, the holding arm, the pivot arm and/or the clamping arm are rotatable.

16. The device of claim 1, wherein the body, the holding arm, the pivot arm and/or the clamping arm are telescopic.

17. The device of claim 1, wherein each of the body, the holding arm, the pivot arm and the clamping arm is independently made of a material selected from the group consisting of polymer, ceramic, wood, aluminum, aluminum alloy and steel.

18. The device of claim 1, wherein the supporting element is selected from the group consisting of table top, desk top, shelf, door, chair and cupboard top.

19. A method for hanging an object on a supporting element, comprising the steps of:
i. Providing the device of claim 1 to an edge of a supporting element; and
ii. Hanging said object onto the holding arm.

20. The method of claim 19, wherein said supporting element is selected from the group consisting of table top, desk top, shelf, door, chair and cupboard top.
